(19) United States
(12) Patent Application Publication
(10) Pub. No.: US 2026/0220891 A1
(43) Pub. Date: Jul. 30, 2026

(54) GENERATING VIRTUAL ENVIRONMENTS USING VISION-LANGUAGE-ACTION MODELS

(71) Applicant: NVIDIA CORPORATION, Santa Clara, CA (US)

(72) Inventors: Jonathan TREMBLAY, Redmond, WA (US); Stanley BIRCHFIELD, Sammamish, WA (US); Fan-Yun SUN, Stanford, CA (US); Valts BLUKIS, Seattle, WA (US); Clemens EPPNER, Seattle, WA (US); Christian Scott JACOBSEN, Santa Clara, CA (US); Shangru LI, Philadelphia, PA (US); Ethem Fatih CAN, Cary, NC (US); Xunlei WU, Cary, NC (US); Alexander ZOOK, Irvine, CA (US)

(21) Appl. No.: 19/412,717

(22) Filed: Dec. 8, 2025

Related U.S. Application Data
(60) Provisional application No. 63/749,457, filed on Jan. 24, 2025.

(51) Int. Cl. G06T 17/20; G06T 7/12; G06V 20/70

(52) U.S. Cl. CPC G06T 17/20; G06T 7/12; G06V 20/70

(57) ABSTRACT

At least one embodiment for generating virtual environments using vision-language-action models includes receiving an input text prompt, generating a first virtual environment based on the input text prompt, generating a second virtual environment by adding a plurality of scene elements to the first virtual environment, and generating a third virtual environment by adding a plurality of additional assets to the second virtual environment, the additional assets being smaller than a first scene element in the plurality of scene elements.

### CROSS-REFERENCE TO RELATED APPLICATIONS

This application claims priority benefit of the United States Provisional Patent Application titled, “TECHNIQUES FOR GENERATING THREE-DIMENSIONAL ENVIRONMENTS USING VISION-LANGUAGE-ACTION MODELS,” filed on Jan. 24, 2025, and having Ser. No. 63/749,457. The subject matter of this related application is hereby incorporated herein by reference.

### BACKGROUND OF THE INVENTION

### Field of the Invention

Embodiments of the present disclosure relate generally to computer graphics, machine learning, and artificial intelligence and, more specifically, to generating three-dimensional environments using vision-language-action models.

### Description of the Related Art

Three-dimensional (3D) graphics design is the task of generating an immersive and interactive 3D environment. 3D graphics design is an important aspect of numerous fields, including gaming, augmented reality, virtual reality, and robotics simulation. 3D graphics content, such as an immersive 3D world for entertainment or robotics simulation, is generated procedurally using a rule-based system with manually designed rules. 3D artists iteratively create detailed 3D worlds by rendering, inspecting, and repeatedly refining the designs with added details and corrections.

One drawback of manual 3D graphics design, however, is that manual 3D graphics design is labor intensive. 3D artists and designers must simultaneously create assets, apply materials, set up lights, and arrange all aspects of an environment. This process is labor-intensive and limits the creation of large-scale synthetic data that can serve as training data to foundation models, be used for downstream synthetic data applications, or used in robotic task simulations.

Recent techniques in 3D graphics design have introduced new ways to accelerate or automate specific components in a traditional 3D graphics workflow using diffusion models and large transformer models. For example, RoboCasa generates 3D scenes using a large language model to select, retrieve and place 3D objects from an asset library, URDFormer uses diffusion models to synthesize textures, and Layout GPT uses a vision language model to generate 3D layouts.

One drawback of using diffusion and large transformer models to create 3D graphics content is that these techniques only automate a specific task (e.g. layout) of the 3D graphics workflow. Another drawback of these techniques is that these techniques are difficult to scale with computational resources, failing to improve the quality of the generated 3D environment with scaling of the computational resources. In addition, these techniques have limited ability to refine or to self-correct the generated environments and are unable to produce separable and manipulable objects within the generated 3D environments, that are needed for many synthetic data applications.

As the foregoing illustrates, what is needed in the art are more effective techniques for generating virtual environments.

### SUMMARY

According to some embodiments, a computer-implemented method for generating a virtual environment. The method includes receiving an input text prompt, generating a first virtual environment based on the input text prompt, generating a second virtual environment by adding a plurality of scene elements to the first virtual environment, and generating a third virtual environment by adding a plurality of additional assets to the second virtual environment, the additional assets being smaller than a first scene element in the plurality of scene elements.

Further embodiments provide, among other things, non-transitory computer-readable storage media storing instructions and systems configured to implement the method set forth above.

At least one technical advantage of the disclosed techniques relative to the prior art is that, with the disclosed techniques large-scale, high-quality virtual environments are generated. The disclosed techniques generate virtual environments where small objects are placed in a semantically coherent manner, thereby ensuring physical plausibility of the virtual environment and generating a virtual environment that is more realistic than prior art approaches to generating virtual environments. In addition, the disclosed techniques iteratively update the virtual environments via self-improvement fine-tuning to generate virtual environments more closely aligned with the input prompt. These technical advantages represent one or more technological improvements over prior art approaches.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the various embodiments;

FIG. 2 is a block diagram of a parallel processing unit included in the parallel processing subsystem of FIG. 1, according to various embodiments;

FIG. 3 is a block diagram of a general processing cluster included in the parallel processing unit of FIG. 2, according to various embodiments;

FIG. 4 is a block diagram of a computer-based system configured to implement one or more aspects of the various embodiments;

FIG. 5 is a more detailed description of the virtual environment generator of FIG. 4, according to various embodiments;

FIG. 6 is a more detailed description of the panoramic environment generator of FIG. 5, according to various embodiments;

FIG. 7 is a more detailed description of the asset level policy of FIG. 5, according to various embodiments;

FIG. 8 is a flow diagram of method steps for generating a virtual environment, according to various embodiments;

FIG. 9 is a flow diagram of method steps for generating a first virtual environment, according to various embodiments; and

FIG. 10 is a flow diagram of method steps for adding large assets to a first virtual environment, according to various embodiments.

FIG. 11 is a flow diagram of method steps for adding smaller assets to a second virtual environment, according to various embodiments.

### DETAILED DESCRIPTION

In the following description, numerous specific details are set forth to provide a more thorough understanding of the present invention. However, it will be apparent to one of skill in the art that the present invention may be practiced without one or more of these specific details.

Embodiments of the present disclosure provide techniques for generating a virtual environment from an input text prompt. First, a panoramic diffusion model is used to generate a 360 degree scene image with a basic structure for the 3D scene. Next, a segmentation model segments windows and doors from the 360 degree scene image. A vision language model inspects each segmented region to determine the type of region and the material of the region. The rooms, doors, and windows are then procedurally constructed in the corresponding 3D locations to create a first virtual environment. The first virtual environment is rendered from multiple views, and a vision language model fine-tuned using a self-improvement strategy based on visual scoring processes the rendered virtual environment and the input text to generate a policy that adds larger assets, such as beds and tables, materials which describe the surface properties (e.g., wood floor, dark polished tiles), and lighting to the first virtual environment to generate a second virtual environment. Next, a mesh-based surface detection approach identifies whether a 3D asset in the second virtual environment is a receptacle object that can host smaller items. The receptacle object is rendered, and a pre-trained vision language model processes the rendered receptacle object and the input text prompt to generate a policy that iteratively introduces smaller assets, such as books or utensils, to the second virtual environment by placing smaller assets on top of larger assets in a semantically aligned and physically plausible way. When the smaller assets have been added, the second virtual environment is output as a final virtual environment that matches the input text prompt.

The techniques for generating a virtual environment from an input text prompt have many real-world applications. For example, these techniques can be used in systems where virtual environments are generated including gaming, augmented reality, virtual reality, and/or the like. These techniques also have applications in vehicle navigation systems, as well as robotics simulation.

The above examples are not in any way intended to be limiting. As persons skilled in the art will appreciate, as a general matter, the techniques for generating virtual environments using vision-language-action models that are described herein can be implemented in any application where generating virtual environments is required or useful.

### System Overview

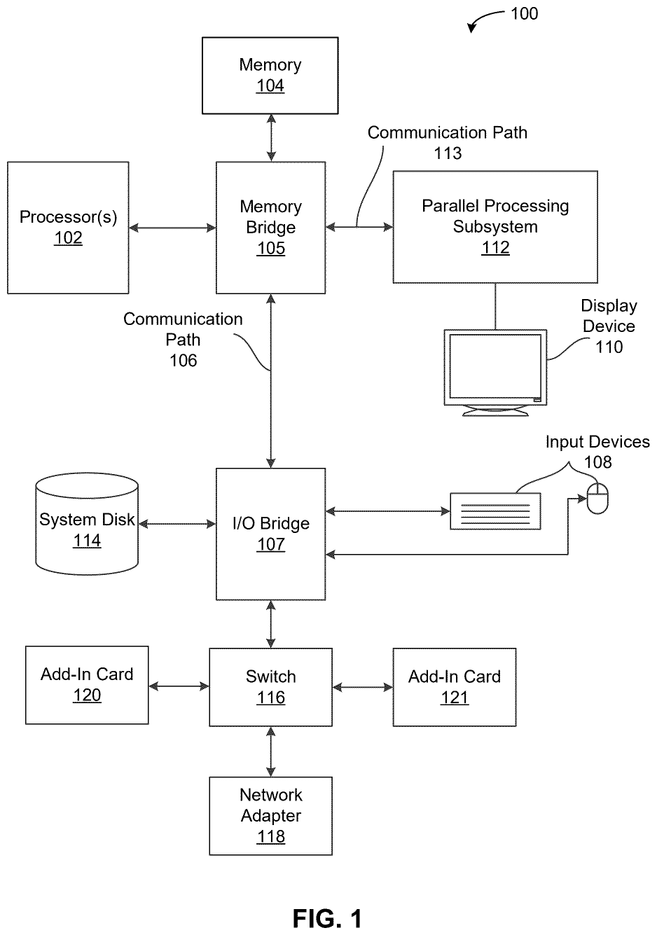

FIG. 1 is a block diagram illustrating a computer system 100 configured to implement one or more aspects of the present embodiments. As persons skilled in the art will appreciate, computer system 100 can be any type of technically feasible computer system, including, without limitation, a server machine, a server platform, a desktop machine, laptop machine, a hand-held/mobile device, or a wearable device. In some embodiments, computer system 100 is a server machine operating in a data center or a cloud computing environment that provides scalable computing resources as a service over a network.

In various embodiments, computer system 100 includes, without limitation, one or more processor(s) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as a keyboard or a mouse, and forward the input information to processor(s) 102 for processing via communication path 106 and memory bridge 105. In some embodiments, computer system 100 may be a server machine in a cloud computing environment. In such embodiments, computer system 100 may not have input devices 108. Instead, computer system 100 may receive equivalent input information by receiving commands in the form of messages transmitted over a network and received via network adapter 118. In one embodiment, switch 116 is configured to provide connections between I/O bridge 107 and other components of computer system 100, such as a network adapter 118 and various add-in cards 120 and 121.

In one embodiment, I/O bridge 107 is coupled to a system disk 114 that may be configured to store content and applications and data for use by processor(s) 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

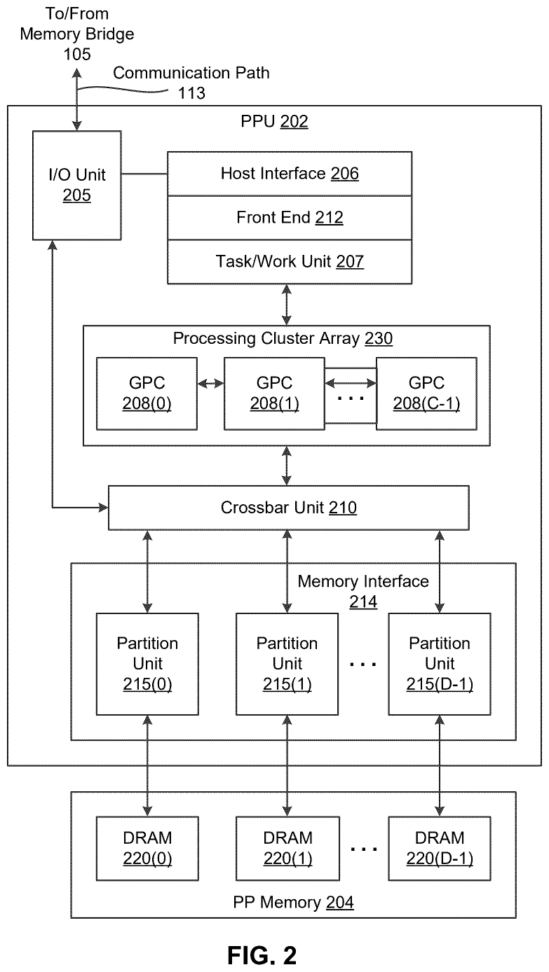

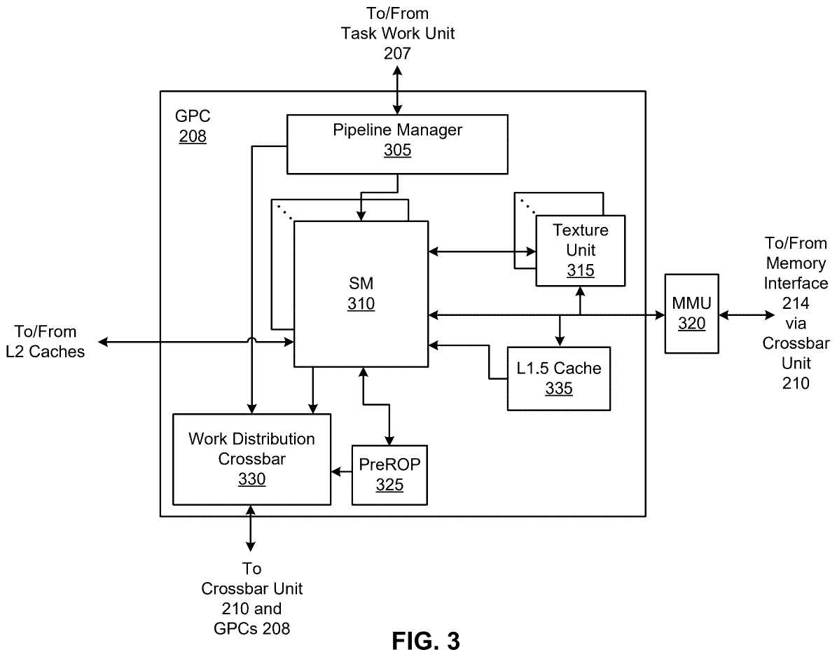

In some embodiments, parallel processing subsystem 112 comprises a graphics subsystem that delivers pixels to an optional display device 110 that may be any conventional cathode ray tube, liquid crystal display, light-emitting diode display, or the like. In such embodiments, parallel processing subsystem 112 incorporates circuitry optimized for graphics and video processing, including, for example, video output circuitry. As described in greater detail below in conjunction with FIGS. 2-3, such circuitry may be incorporated across one or more parallel processing units (PPUs), also referred to herein as parallel processors, included within parallel processing subsystem 112. In other embodiments, parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver configured to manage the processing operations of the one or more PPUs within parallel processing subsystem 112.

In various embodiments, parallel processing subsystem 112 may be integrated with one or more of the other elements of FIG. 1 to form a single system. For example, parallel processing subsystem 112 may be integrated with processor(s) 102 and other connection circuitry on a single chip to form a system on chip (SoC).

In one embodiment, processor(s) 102 include the master processor of computer system 100, controlling and coordinating operations of other system components. In one embodiment, processor(s) 102 issue commands that control the operation of PPUs. In some embodiments, communication path 113 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of processors 102, and the number of parallel processing subsystems 112, may be modified as desired. For example, in some embodiments, system memory 104 could be connected to processor(s) 102 directly rather than through memory bridge 105, and other devices would communicate with system memory 104 via memory bridge 105 and processor(s) 102. In other embodiments, parallel processing subsystem 112 may be connected to I/O bridge 107 or directly to processor(s) 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 could be eliminated, and network adapter 118 and add-in cards 120, 121 would connect directly to I/O bridge 107. Lastly, in certain embodiments, one or more components shown in FIG. 1 may be implemented as virtualized resources in a virtual computing environment, such as a cloud computing environment. In particular, parallel processing subsystem 112 may be implemented as a virtualized parallel processing subsystem in some embodiments. For example, parallel processing subsystem 112 could be implemented as a virtual graphics processing unit (GPU) that renders graphics on a virtual machine (VM) executing on a server machine whose GPU and other physical resources are shared across multiple VMs.

FIG. 2 is a block diagram of a parallel processing unit (PPU) 202 included in parallel processing subsystem 112 of FIG. 1, according to various embodiments. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a GPU that may be configured to implement a graphics rendering pipeline to perform various operations related to generating pixel data based on graphics data supplied by processor(s) 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to an optional display device 110 for display. In some embodiments, PPU 202 also may be configured for general-purpose processing and compute operations. In some embodiments, computer system 100 may be a server machine in a cloud computing environment. In such embodiments, computer system 100 may not have a display device 110. Instead, computer system 100 may generate equivalent output information by transmitting commands in the form of messages over a network via network adapter 118.

In some embodiments, processor(s) 102 include the master processor of computer system 100, controlling and coordinating operations of other system components. In one embodiment, processor(s) 102 issue commands that control the operation of PPU 202. In some embodiments, processor(s) 102 write a stream of commands for PPU 202 to a data structure (not explicitly shown in either FIG. 1 or FIG. 2) that may be located in system memory 104, PP memory 204, or another storage location accessible to both processor(s) 102 and PPU 202. A pointer to the data structure is written to a command queue, also referred to herein as a pushbuffer, to initiate processing of the stream of commands in the data structure. In one embodiment, PPU 202 reads command streams from the command queue and then executes commands asynchronously relative to the operation of processor(s) 102. In embodiments where multiple pushbuffers are generated, execution priorities may be specified for each pushbuffer by an application program via device driver to control scheduling of the different pushbuffers.

In one embodiment, PPU 202 includes an I/O (input/output) unit 205 that communicates with the rest of computer system 100 via communication path 113 and memory bridge 105. In one embodiment, I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. In one embodiment, host interface 206 reads each command queue and transmits the command stream stored in the command queue to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with processor(s) 102 in a single integrated circuit or system of chip (SoC).

In one embodiment, front end 212 transmits processing tasks received from host interface 206 to a work distribution unit (not shown) within task/work unit 207. In one embodiment, the work distribution unit receives pointers to processing tasks that are encoded as task metadata (TMD) and stored in memory. The pointers to TMDs are included in a command stream that is stored as a command queue and received by front end unit 212 from host interface 206. Processing tasks that may be encoded as TMDs include indices associated with the data to be processed as well as state parameters and commands that define how the data is to be processed. For example, the state parameters and commands could define the program to be executed on the data. Also, for example, the TMD could specify the number and configuration of the set of CTAs. Generally, each TMD corresponds to one task. The task/work unit 207 receives tasks from front end 212 and ensures that GPCs 208 are configured to a valid state before the processing task specified by each one of the TMDs is initiated. A priority may be specified for each TMD that is used to schedule the execution of the processing task. Processing tasks also may be received from processing cluster array 230. Optionally, the TMD may include a parameter that controls whether the TMD is added to the head or the tail of a list of processing tasks (or to a list of pointers to the processing tasks), thereby providing another level of control over execution priority.

In one embodiment, PPU 202 implements a highly parallel processing architecture based on a processing cluster array 230 that includes a set of C general processing clusters (GPCs) 208, where C³1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

In one embodiment, memory interface 214 includes a set of D of partition units 215, where D³1. Each partition unit 215 is coupled to one or more dynamic random access memories (DRAMs) 220 residing within PPM memory 204. In some embodiments, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

In one embodiment, a given GPC 208 may process data to be written to any of the DRAMs 220 within PP memory 204. In one embodiment, crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In some embodiments, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between GPCs 208 and partition units 215.

In one embodiment, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including processor(s) 102, another PPU 202 within parallel processing subsystem 112, or another parallel processing subsystem 112 within computer system 100.

In one embodiment, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, wearable devices, servers, workstations, game consoles, embedded systems, and the like.

FIG. 3 is a block diagram of a general processing cluster (GPC) 208 included in the parallel processing unit (PPU) 202 of FIG. 2, according to various embodiments. As shown, GPC 208 includes, without limitation, a pipeline manager 305, one or more texture units 315, a preROP unit 325, a work distribution crossbar 330, and an L1.5 cache 335.

In one embodiment, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

In one embodiment, operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In various embodiments, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, 5OR), bit-shifting, and computation of various algebraic functions (e.g., planar interpolation and trigonometric, exponential, and logarithmic functions, etc.). Advantageously, the same functional execution unit can be configured to perform different operations.

In one embodiment, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within SM 310, in which case some of the execution may be idle during cycles when that thread group is being processed. A thread group may also include more threads than the number of execution units within SM 310, in which case processing may occur over consecutive clock cycles. Since each SM 310 can support up to G thread groups concurrently, it follows that up to G*M thread groups can be executing in GPC 208 at any given time.

Additionally, in one embodiment, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within SM 310, and m is the number of thread groups simultaneously active within SM 310. In some embodiments, a single SM 310 may simultaneously support multiple CTAs, where such CTAs are at the granularity at which work is distributed to SMs 310.

In one embodiment, each SM 310 contains a level one (L1) cache or uses space in a corresponding L1 cache outside of SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, SMs 310 may beneficially share common instructions and data cached in L1.5 cache 335.

In one embodiment, each GPC 208 may have an associated memory management unit (MMU) 320 that is configured to map virtual addresses into physical addresses. In various embodiments, MMU 320 may reside either within GPC 208 or within memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In one embodiment, in graphics and compute applications, GPC 208 may be configured such that each SM 310 is coupled to a texture unit 315 for performing texture mapping operations, such as determining texture sample positions, reading texture data, and filtering texture data.

In one embodiment, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs.

### Generated Virtual Environments Generation and Use

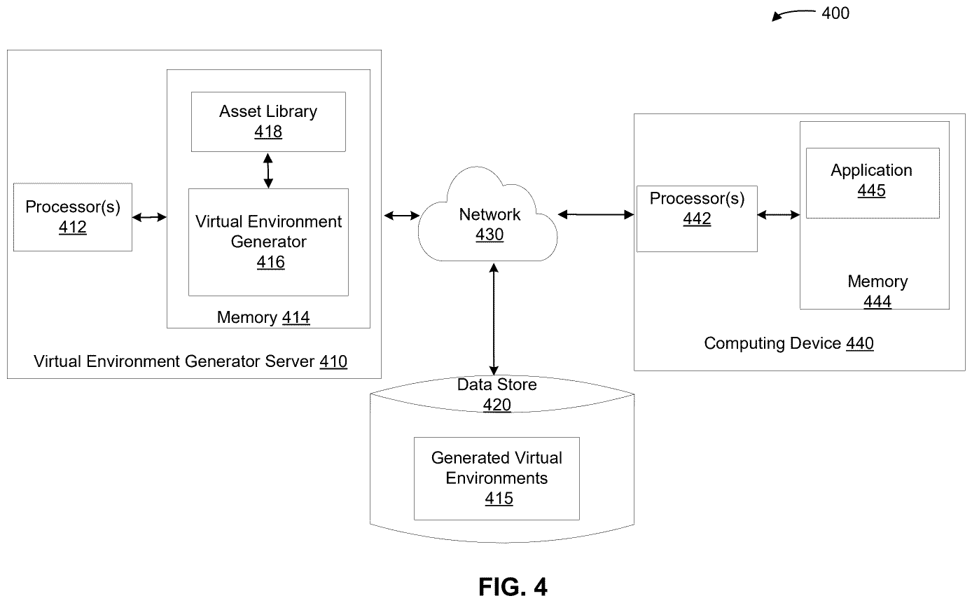

FIG. 4 illustrates a block diagram of a computer-based system 400 configured to implement one or more aspects of the various embodiments. As shown, computer-based system 400 includes, without limitation, a virtual environment generator server 410, a data store 420, a network 430, and a computing device 440. Virtual environment generator server 410 includes, without limitation, processor(s) 412 and a memory 414. Memory 414 includes, without limitation, virtual environment generator 416 and asset library 418. Computing device 440 includes, without limitation, processor(s) 442 and memory 444. Memory 444 includes, without limitation, an application 445. Data store 420 stores, without limitation, generated virtual environments 415. Each of the virtual environment generator server 410 and the computing device 440 can include similar components, features, and/or functionality as the exemplary computer system 100, described above in conjunction with FIG. 1-3. Each of virtual environment generator server 410 and computing device 440 can be any technically feasible type of computer system, including, without limitation, a server machine or a server platform.

Virtual environment generator server 410 shown herein is for illustrative purposes only, and variations and modifications are possible without departing from the scope of the present disclosure. For example, the number and types of processor(s) 412, the number of GPUs and/or other processing unit types, the number and types of memories 414, and/or the number of applications included in the memory 414 can be modified as desired. Further, the connection topology between the various units within virtual environment generator server 410 can be modified as desired. In some embodiments, any combination of the processor(s) 412 and the memory 414, and/or GPU(s) can be included in and/or replaced with any type of virtual computing system, distributed computing system, and/or cloud computing environment, such as a public, private, or a hybrid cloud system.

Processor(s) 412 receive user input from input devices, such as a keyboard or a mouse. Processor(s) 412 can be any technically feasible form of processing device configured to process data and execute program code. For example, any of processor(s) 412 could be a central processing unit (CPU), a graphics processing unit (GPU), an application-specific integrated circuit (ASIC), a field-programmable gate array (FPGA), and so forth. In various embodiments any of the operations and/or functions described herein can be performed by processor(s) 412, or any combination of these different processors, such as a CPU working in cooperation with one or more GPUs. In various embodiments, the processor(s) 412 can issue commands that control the operation of one or more GPUs (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

Memory 414 of virtual environment generator server 410 stores content, such as software applications and data, for use by processor(s) 412. Memory 414 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace memory 414. The storage can include any number and type of external memories that are accessible to processor(s) 412. For example, and without limitation, the storage can include a Secure Digital Card, an external Flash memory, a portable compact disc read-only memory (CD-ROM), an optical storage device, a magnetic storage device, and/or any suitable combination of the foregoing.

Asset library 418 is a repository of scene elements and additional assets. In various embodiments, scene elements of asset library 418 includes 3D objects, materials, and lighting. 3D objects include larger assets, such as tables, chairs, and/or the like. Materials describe the surface properties of the 3D objects, such as the texture and surface type. In various embodiments, the materials of asset library 418 include wood, glass, fabric and/or the like. Lighting describes the type, intensity, and color of light. In various embodiments, additional assets of asset library 418 include smaller assets, such as books, plates, utensils and/or the like. Although not shown in FIG. 4, asset library 418 can be loaded from data store 420 and/or one or more other data repositories.

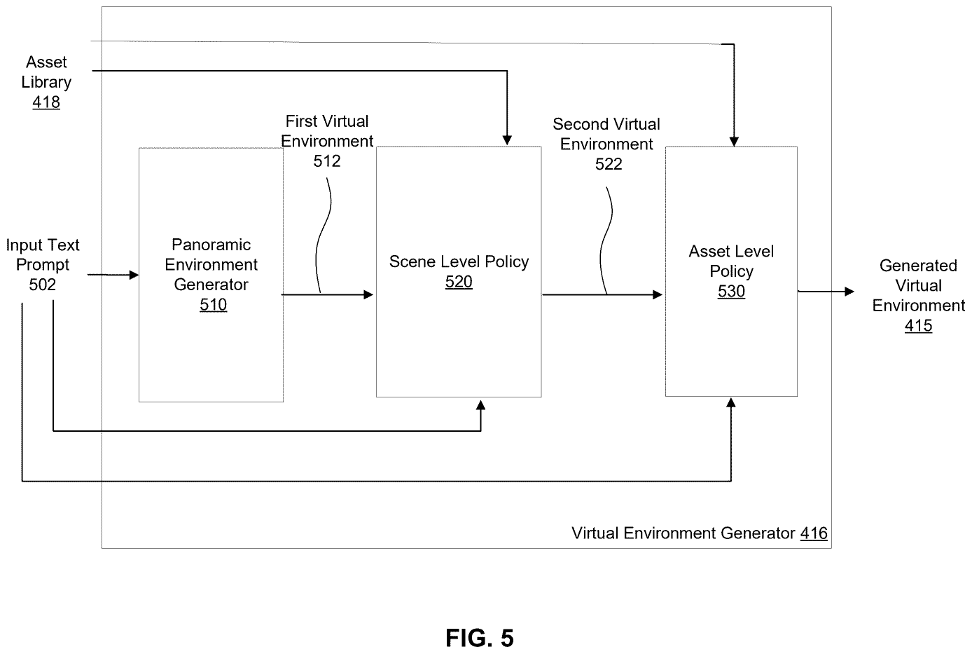

Virtual environment generator 416 is configured to generate generated virtual environments 415 using asset library 418. In various embodiments, virtual environment generator 416 generates a virtual environment 415 that is a 3D environment. First, virtual environment generator receives an input text prompt, then uses a panoramic diffusion model to generate a 360 degree scene image with a basic structure. Next, a segmentation model segments windows and doors from the 360 degree scene image and a vision language model inspects each segmented region to determine the type of region and the material of the region. The rooms, doors, and windows are then procedurally constructed in the corresponding 3D locations to create a first virtual environment. The first virtual environment is rendered from multiple views, and the rendered virtual environment and the input text prompt 502 are processed by a vision language model. The vision language model iteratively adds larger assets and materials from the asset library 418 to the first virtual environment to generate a second virtual environment. Smaller assets are then added to the second virtual environment from the asset library 418 using a pre-trained vision language model. After the smaller assets have been added to the second virtual environment, virtual environment generator 416 outputs a generated virtual environment 415 that matches the input text prompt. The operations performed by virtual environment generator 416 to generate generated virtual environments 415 are described in greater detail below in conjunction with FIG. 5-7.

Data store 420 provides non-volatile storage for applications and virtual environment generator server 410 and computing device 440. For example, and without limitation, training data, trained (or deployed) machine learning models and/or application data, asset library 418, generated virtual environments 415 can be stored in the data store 420 for use by application 445. In some embodiments, data store 420 can include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Data store 420 can be a network attached storage (NAS) and/or a storage area-network (SAN). Although shown as coupled to virtual environment generator server 410 and computing device 440 via network 430, in various embodiments, virtual environment generator server 410 or computing device 440 can include data store 420.

Network 430 includes any technically feasible type of communications network that allows data to be exchanged between virtual environment generator server 410, computing device 440, data store 420 and external entities or devices, such as a web server or another networked computing device. For example, network 430 can include a wide area network (WAN), a local area network (LAN), a cellular network, a wireless (WiFi) network, and/or the Internet, among others.

Computing device 440 shown herein is for illustrative purposes only, and variations and modifications are possible without departing from the scope of the present disclosure. For example, the number and types of processor(s) 442, the number and types of memories 444, and/or the number of applications included in the memory 444 can be modified as desired. Further, the connection topology between the various units within computing device 440 can be modified as desired. In some embodiments, any combination of the processor(s) 442 and/or the memory 444 can be included in and/or replaced with any type of virtual computing system, distributed computing system, and/or cloud computing environment, such as a public, private, or a hybrid cloud system. In various embodiments, computing device 440 can be implemented using any of the computing devices of FIGS. 1-3.

Similar to processor(s) 412, processor(s) 442 receive user input from input devices, such as a keyboard or a mouse. Processor(s) 442 can be any technically feasible form of processing device configured to process data and execute program code. For example, any of processor(s) 442 could be a CPU, a GPU, an ASIC, a FPGA, and so forth. In various embodiments any of the operations and/or functions described herein can be performed by processor(s) 442, or any combination of these different processors, such as a CPU working in cooperation with a one or more GPUs. In various embodiments, the one or more GPU(s) perform parallel processing task, such as matrix multiplications and/or the like in LLM model computations. Processor(s) 442 can also receive user input from input devices, such as a keyboard or a mouse and generate output on one or more displays.

Similar to memory 414 of virtual environment generator server 410, memory 444 of computing device 440 stores content, such as software applications and data, for use by the processor(s) 442. The memory 444 can be any type of memory capable of storing data and software applications, such as a RAM, ROM, EPROM, Flash ROM, or any suitable combination of the foregoing. In some embodiments, a storage (not shown) can supplement or replace the memory 444. The storage can include any number and type of external memories that are accessible to processor(s) 442. For example, and without limitation, the storage can include a Secure Digital Card, an external Flash memory, a portable CD-ROM, an optical storage device, a magnetic storage device, and/or any suitable combination of the foregoing.

As shown, memory 444 includes application 445. Application 445 can be, without limitation, any type of vision foundation model, video game, or robotics simulation application. For example, application 445 can receive generated virtual environments 415 and use generated virtual environments 415 to train a vision foundation model. In various embodiments, application 445 can use generated virtual environments 415 to populate an immersive 3D world of a video game with objects.

FIG. 5 is a more detailed illustration of virtual environment generator 416, according to various embodiments. As shown, virtual environment generator 416 includes, without limitation, a panoramic environment generator 510, a scene level policy 520, and an asset level policy 530. Panoramic environment generator receives input text prompt 502 and generates first virtual environment 512. Scene level policy 520 receives first virtual environment 512, input text prompt 502, and asset library 418 and generates second virtual environment 522. Asset level policy 530 receives second virtual environment 522, input text prompt 502, and asset library 418 and generates generated virtual environment 415. virtual environment generator 416 receives input text prompt 502, and asset library 418 and generates generated virtual environments 415.

Input text prompt 502 is text provided by a user to virtual environment generator 416. In various embodiments, input text prompt 502 is a simple sentence, or a more detailed instruction. For example, input text prompt 502 can include a description, such as “a quaint bookstore,” or “modern bar with brick wall and marble bar counter.”

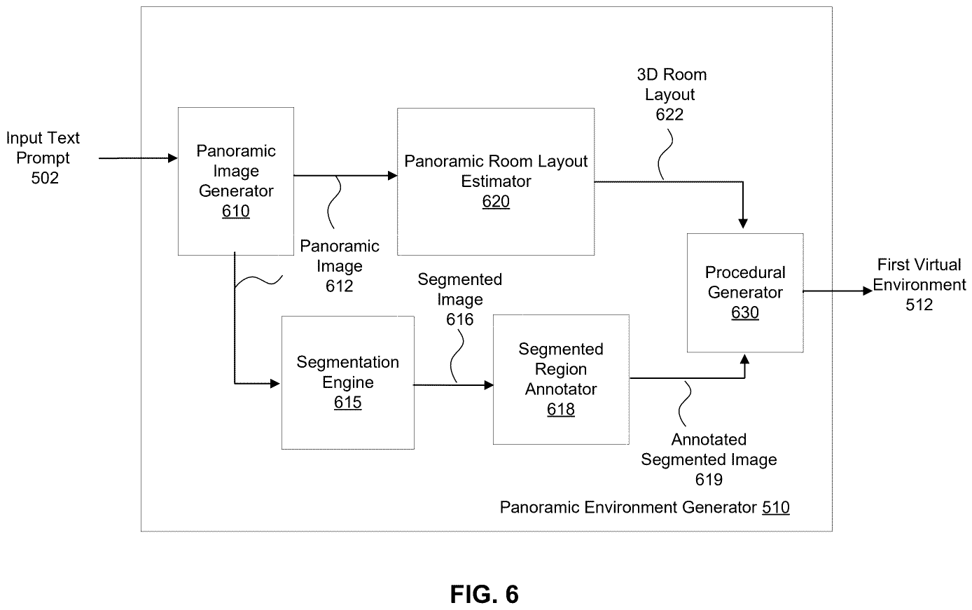

Panoramic environment generator 510 receives input text prompt 502 and generates first virtual environment 512. Panoramic environment generator 510 receives an input text prompt and uses a panoramic diffusion model to generate a 360 degree scene image with a basic structure. Panoramic environment generator 510 then uses a segmentation model to segment windows and doors from the 360 degree scene image followed by a vision language model to determine the type of region and the material of the segmented region. Panoramic environment generator 510 then procedurally constructs the windows and doors in the 360 degree scene to generate first virtual environment 512. The operations of panoramic environment generator 510 are described in conjunction with FIG. 6.

Scene level policy 520 receives first virtual environment 512, input text prompt 502, and asset library 418 and generates second virtual environment 522. Scene level policy 520 is configured to add large assets from asset library 418 to first virtual environment 512. First, scene level policy 520 renders the first virtual environment 512, S₀, from multiple views to generate a set of multi-view images, I₀. Next, scene level policy 520 inputs the set of multi-view images, I₀, and input text prompt 502, P, into a vision language model π_{θ}, parameterized by θ. The vision language action model outputs an action code a₀~π_{θ}(a|I₀,P) that indicates which large assets or materials from asset library 418 are to be retrieved and added to first virtual environment 512. Scene level policy 520 then updates the first virtual environment 512 by executing the action code a₀. In various embodiments, the action code is executed using exposed tools and function application programming interfaces (APIs) allowing different software applications to communicate. Upon execution of the action policy, scene level policy 520, for example, adjusts the position of a bathtub, adds a table, or increases the lighting of first virtual environment 512 to generate an updated first 3D scene, S₁. Scene level policy 520 then repeats the above steps on the updated first virtual environment S₁. After a user specified number of iterations, t, scene level policy 520 generates a second virtual environment 522, Sₜ. The second virtual environment 522 is the first virtual environment 512 with large assets, materials, and lighting added.

In various embodiments, the vision language action model of scene level policy 520 is trained using a self-improvement visual scoring strategy. In each training round, the vision language model,

$${π}_{θ}^{( i )} ,$$

where i denotes the ith training round, generates multiple candidate actions. The actions that yield the highest contrastive language image pre training (CLIP) score between the updated virtual environments and the input text prompt 502 are retained. The actions with the highest CLIP scores are then used to update the parameters of the vision language model, resulting in an improved model

$${π}_{θ}^{( i + 1 )} .$$

The improved model

$${π}_{θ}^{( i + 1 )}$$

can generate new tasks and update virtual environments. In various embodiments, the vision language model uses an in-context library to enhance CLIP scores. The in-context library can be a curated collection of action codes that have demonstrated at least a ten percent improvement in CLIP scores when modifying a virtual environment.

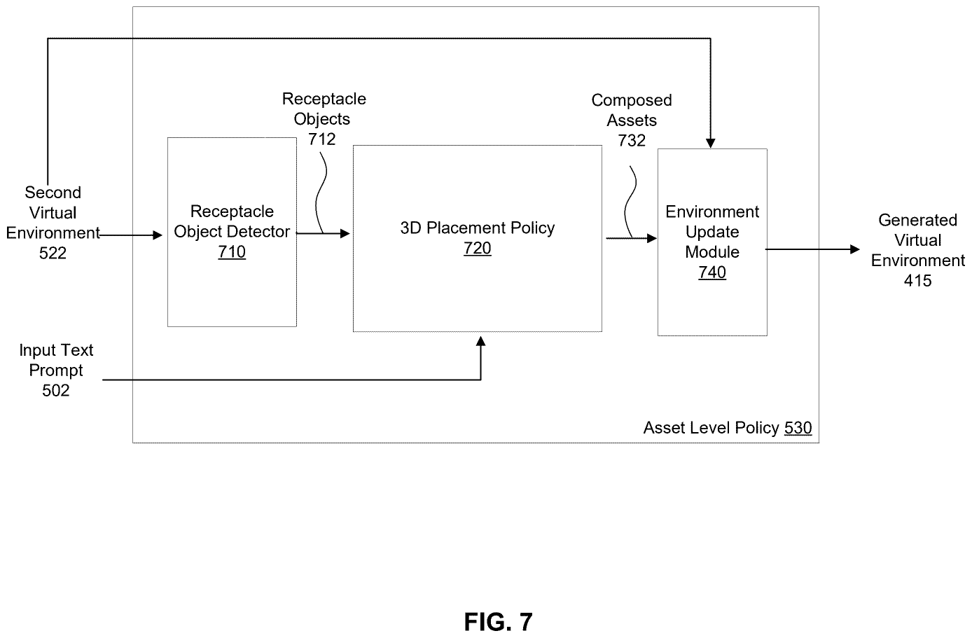

Asset level policy 530 receives second virtual environment 522, input text prompt 502, and asset library 418 and generates generated virtual environment 415. Asset level policy 530 is configured to add smaller assets from asset library 418 to second virtual environment 522. Asset level policy 530 first identifies whether a 3D asset in the second virtual environment 522 qualifies as a receptacle object using a mesh-based surface detection approach. A receptacle object is an object that can host smaller items. The receptacle object is rendered, and the rendered receptacle object and the input text prompt are processed by a pre-trained vision language model. The vison language model generates a policy that iteratively introduces smaller assets to the second virtual environment 522 by placing smaller assets on top of larger assets in a semantically aligned and physically plausible way. Asset level policy 530 generates generated virtual environment 415 as the second virtual environment 522 with the smaller assets added, that matches the input text prompt 502. The operations of asset level policy 530 are described in more detail in conjunction with FIG. 7.

FIG. 6 is a more detailed illustration of panoramic environment generator 510 of FIG. 5, according to various embodiments. As shown, panoramic environment generator 510 includes, without limitation, a panoramic image generator 610, a segmentation engine 615, a segmented region annotator 618, a panoramic room layout estimator 620, and a procedural generator 630. Panoramic image generator 610 receives input text prompt 502 and generates panoramic image 612. Segmentation engine 615 receives panoramic image 612 and generates segmented image 616. Segmented region annotator 618 receives segmented image 616 and generates annotated segmented image 619. Panoramic room layout estimator 620 receives panoramic image 612 and generates 3D room layout 622. Procedural generator 630 receives annotated segmented image 619 and 3D room layout 622 and generates first virtual environment 512. Panoramic environment generator 510 receives input text prompt 502 and generates first virtual environment 512.

Panoramic image generator 610 is configured to generate panoramic image 612 based on input text prompt 502. Panoramic image generator 610 can be any type of technically feasible machine learning model. For example, in various embodiments, panoramic image generator 610 can be a diffusion model with any suitable architecture. More generally, the input data set to panoramic image generator 610 can include any technically feasible data that can be processed by a diffusion model for image generation. Panoramic image generator 610 takes an input text prompt 502 and generates a panoramic image 612. A panoramic image 612 is a 360 degree image that captures the entire 360 degree by 180 degree field of view. Panoramic image generator 610 then passes panoramic image 612 to segmentation engine 615 and panoramic room layout estimator 620.

Panoramic room layout estimator 620 is configured to estimate the 3D room layout 622 of a panoramic image 612. Panoramic room layout estimator 620 can be any type of technically feasible machine learning model. For example, in various embodiments, panoramic room layout estimator 620 can be a recurrent neural network with any suitable architecture. Panoramic room layout estimator 620 processes a single panoramic image 612 with dimension 3×512×1024 (channel, height, width) and represents the 3D room layout 622 of the panoramic image 612 as three vectors, y_{f}, y_{c}, y_{w} each of size 1×1024, where each value in y_{f} represents a floor-wall boundary position, each value in y_{c} represents a ceiling-wall boundary position, and y_{w} represents the probability of a wall-wall boundary (e.g., corners). Panoramic room layout estimator 620 then passes 3D room layout 622 to procedural generator 630.

Segmentation engine 615 is configured to segment fixtures from panoramic image 612. Fixtures of panoramic image 612 include, without limitation, windows and doors. Segmentation engine 615 can be any technically feasible machine learning model. For example, in various embodiments, segmentation engine 615 can be a pre-trained vision transformer with any suitable architecture. More generally, the input data set to segmentation engine 615 can include any technically feasible data that can be processed by a transformer-based model for computer vision. Segmentation engine 615 can include multiple layers, including an attention layer, a multilayer perceptron (MLP) layer, a layer norm layer, a convolutional layer, a pooling layer, a softmax layer, and/or any other type of viable artificial neural network layer, and/or the like. Each layer of segmentation engine 615 has varying numbers of internal parameters including, without limitation, numbers of attention heads, key-value projection dimensions, numbers of neurons, types of activation functions, and/or the like. Segmentation engine 615 processes panoramic image 612 and generates segmented image 616. Segmented image 616 is panoramic image 612 where fixtures, such as windows and door, are segmented out. Segmentation engine 615 passes segmented image 616 to segmented region annotator 618.

Segmented region annotator 618 receives segmented image 616 and generates annotated segmented image 619. Segmented region annotator 618 can be any technically feasible machine learning model. For example, in various embodiments segmented, region annotator 618 is a vision language model. Segmented region annotator 618 inspects each segmented fixture of segmented image 616 and annotates the type and material of each segmented fixture of segmented image 616. For example, and without limitation, segmented region annotator 618 inspects a segmented fixture of segmented image 616 and determines if the segmented fixture is a single door, double door, or sliding door and determines the corresponding materials, such as door frame material, door material, and doorknob material. Segmented region annotator 618 generates annotated segmented image 619 as segmented image 616 with all segmented fixtures annotated. Segmented region annotator 618 then passes annotated segmented image 619 to procedural generator 630.

Procedural generator 630 receives annotated segmented image 619 and 3D room layout 622 and generates first virtual environment 512. Procedural generator 630 can be any technically feasible machine learning model. Given annotated segmented image 619 and 3D room layout 622, procedural generator 630 uses a multi-stage conditional sampling technique to iteratively generate first virtual environment 512. First virtual environment 512 is a complete scene layout where the rooms, doors and windows are constructed in the corresponding 3D locations given by annotated segmented image and 3D room layout 622.

FIG. 7 is a more detailed illustration of asset level policy 530 of FIG. 5, according to various embodiments. As shown, asset level policy 530 includes, without limitation, a receptacle object detector 710, a 3D placement policy 720, and an environment update module 740. Receptacle object detector 710 receives second virtual environment 522 and generates receptacle objects 712. 3D placement policy 720 receives receptacle objects 712 and input text prompt 502 and generates composed assets 732. Environment update module 740 receives composed assets 732 and generates generated virtual environment 415. Asset level policy 530 receives second virtual environment 522 and input text prompt 502 and generates generated virtual environment 415.

Receptacle object detector 710 receives second virtual environment 522 from scene level policy 520. Receptacle object detector 710 can be any technically feasible machine learning model. For example, in various embodiments, receptacle object detector 710 can be a pre-trained vision transformer with any suitable architecture. More specifically, the input data set to receptacle object detector 710 can be any combination of text, audio, image or video, and receptacle object detector 710 generates any combination of text, audio, image or video. Receptacle object detector 710 determines the objects in second virtual environment 522 that are receptacle objects 712. A receptacle object 712 is a larger asset, such as a shelf, table, or counter, where smaller assets, such as books, plates, or utensils, can be placed. Receptacle object detector 710 then passes receptacle objects 712 to 3D placement policy 720.

3D placement policy 720 receives receptacle objects 712 and asset library 418. First, 3D placement policy 720 uses a mesh-based surface detection approach to find valid surfaces on each receptacle object 712 where smaller assets can be placed. Next, 3D placement policy 720 renders each receptacle object 712 from a randomly sampled angle on a hemisphere, to generate an image rendering for each receptacle object 712. 3D placement policy 720 then processes each rendered receptacle image and input text prompt 502 using a pre-trained vision language model,

$${π}_{ϕ}^{′} ,$$

where φ are the parameters of the pre-trained vision language model. The pre-trained vision language model outputs an action

$${a}_{k}^{′} = ( {o}_{k}^{′} , {p}_{k}^{′} ) ,$$

where

$${o}_{k}^{′}$$

denotes the pixel location in a rendered receptacle image indicating the placement position of a smaller asset on the receptacle object, and

$${p}_{k}^{′}$$

represents the text description used to retrieve the smaller 3D asset from asset library 418. Next, using the pixel location

$${o}_{k}^{′}$$

and the associated camera parameters, 3D placement policy 720 generates a 3D ray to identify a precise placement point of the smaller asset on the receptacle object. If the location intersects one of the previously identified valid surfaces, then 3D placement policy 720 retrieves the asset from asset library 418 specified by pₖ′ and generates a composed asset 732. 3D placement policy repeats the above procedure with the composed asset to generate a set of composed assets 732.

Environment update module 740 receives composed assets 732 from 3D placement policy 720 and second virtual environment 522. Environment update module 740 updates second virtual environment 522 using composed assets 732 where the receptacle objects in second virtual environment 522 are replaced by the corresponding composed assets 732. The generated virtual environment 415 is the updated second virtual environment 522 with composed assets that closely matches the input text prompt 502.

### Generating Generated Virtual Environments

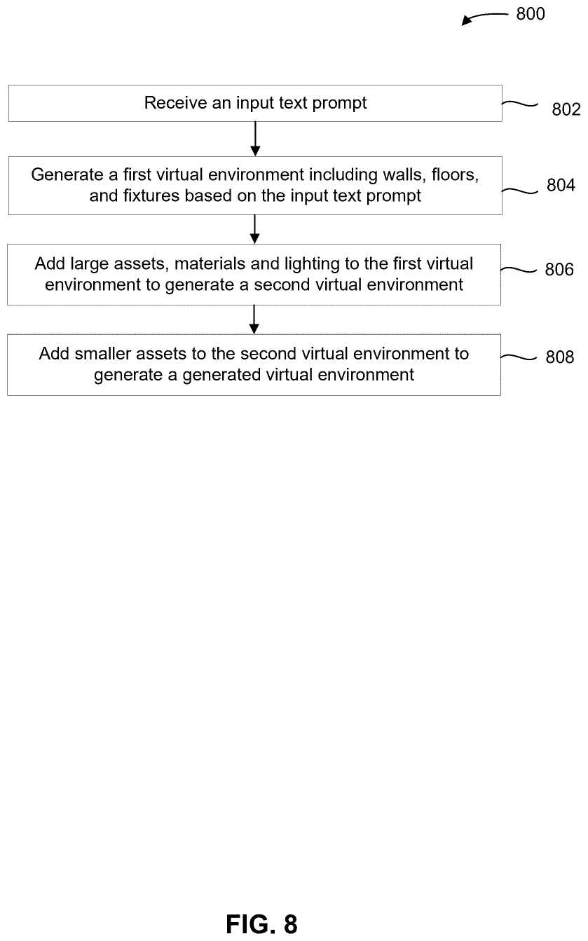

FIG. 8 is a flow diagram of method steps for generating a generated virtual environment according to various embodiments. Although the method steps are described in conjunction with the systems of FIG. 1-7, persons skilled in the art will understand that any system configured to perform the method steps, in any order, falls within the scope of the various embodiments.

As shown, a method 800 begins at step 802, where virtual environment generator 416 receives an input text prompt 502. Input text prompt 502 is text provided by a user to virtual environment generator 416. In various embodiments, input text prompt 502 is a simple sentence, or a more detailed instruction. For example, input text prompt 502 can include a description, such as “a quaint bookstore,” or “modern bar with brick wall and marble bar counter.”

At step 804, panoramic environment generator 510 generates a first virtual environment 512 including walls, floors, and fixtures based on the input text prompt 502. More specifically, panoramic environment generator 510 receives an input text prompt and uses a panoramic diffusion model to generate a 360 degree scene image with a basic structure. Panoramic environment generator 510 then uses a segmentation model to segment windows and doors from the 360 degree scene image followed by a vision language model to determine the type of region and the material of the segmented region. Panoramic environment generator 510 then procedurally constructs the windows and doors in the 360 degree scene to generate first virtual environment 512.

At step 806, scene level policy 520 adds large assets, materials, and lighting to the first virtual environment 512 to generate a second virtual environment 522. Scene level policy 520 is configured to add large assets from asset library 418 to first virtual environment 512. Scene level policy first renders the first virtual environment from multiple views, and a vision language model processes the rendered first virtual environment and the input text to generate a policy that adds larger assets, such as beds and tables, materials which describe the surface properties (e.g., wood floor, dark polished tiles), and lighting to the first virtual environment to generate a second virtual environment.

At step 808, asset level policy 530 adds smaller assets to the second virtual environment to generate a generated virtual environment. Asset level policy 530 first identifies whether a 3D asset in the second virtual environment 522 qualifies as a receptacle object using a mesh-based surface detection approach. A receptacle object is an object that can host smaller items. The receptacle object is rendered, and the rendered receptacle object and the input text prompt are processed by a pre-trained vision language model. The vison language model generates a policy that iteratively introduces smaller assets to the second virtual environment 522 by placing smaller assets on top of larger assets in a semantically aligned and physically plausible way. Asset level policy 530 generates generated virtual environment 415 as the second virtual environment 522 with the smaller assets added, that matches the input text prompt 502.

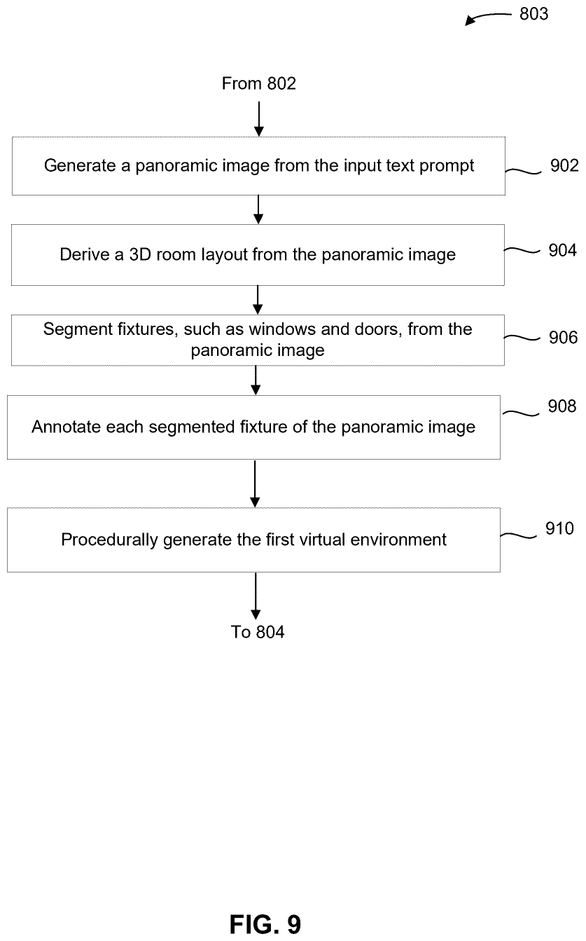

FIG. 9 is a flow diagram of method steps for generating a first virtual environment, according to various embodiments. Although the method steps are described in conjunction with the systems of FIGS. 1-7, persons skilled in the art will understand that any system configured to perform the method steps, in any order, falls within the scope of the various embodiments.

As shown, step 803 begins at step 902, where panoramic image generator 610 generates a panoramic image 612. Panoramic image generator 610 can be any type of technically feasible machine learning model, such as a diffusion model, with any suitable architecture. Panoramic image generator 610 takes an input text prompt 502 and generates a panoramic image 612. A panoramic image 612 is a 360 degree image that captures the entire 360 degree by 180 degree field of view.

At step 904 panoramic room layout estimator 620 derives the 3D room layout 622 from the panoramic image 612. Panoramic room layout estimator 620 processes a single panoramic image 612 with dimension 3×512×1024 (channel, height, width) and represents the 3D room layout 622 of the panoramic image 612 as three vectors, y_{f}, y_{c}, y_{w} each of size 1×1024, where each value in y_{f} represents a floor-wall boundary position, each value in y_{c} represents a ceiling-wall boundary position, and y_{w} represents the probability of a wall-wall boundary (e.g., corners).

At step 906, segmentation engine 615 segments fixtures, such as windows and doors, from the panoramic image 612. Segmentation engine 615 processes panoramic image 612 and generates segmented image 616. Segmented image 616 is panoramic image 612 where fixtures, such as windows and door, are segmented out.

At step 908, segmented region annotator 618 annotates each segmented fixture of the panoramic image 612. Segmented region annotator 618 inspects each segmented fixture of segmented image 616 and annotates the type and material of each segmented fixture of segmented image 616. For example, and without limitation, segmented region annotator 618 inspects a segmented fixture of segmented image 616 and determines if the segmented fixture is a single door, double door, or sliding door and determines the corresponding materials, such as door frame material, door material, and doorknob material. Segmented region annotator 618 generates annotated segmented image 619 as segmented image 616 with all segmented fixtures annotated.

At step 910, procedural generator 630 procedurally generates a first virtual environment 512. Given annotated segmented image 619 and 3D room layout 622, procedural generator 630 uses a multi-stage conditional sampling technique to iteratively generate first virtual environment 512. First virtual environment 512 is a complete scene layout where the rooms, doors and windows are constructed in the corresponding 3D locations given by annotated segmented image and 3D room layout 622.

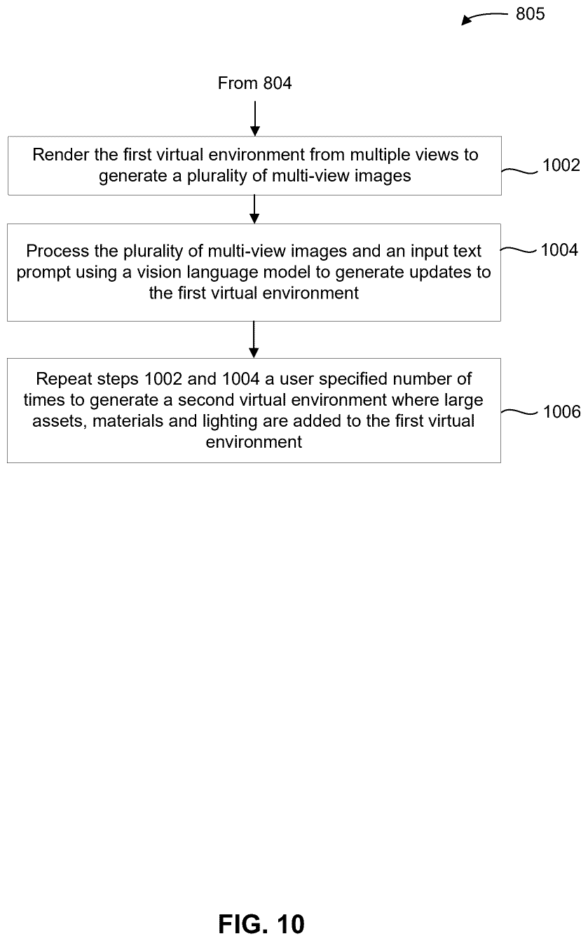

FIG. 10 is a flow diagram of method steps for adding larger assets to a first virtual environment according to various embodiments. Although the method steps are described in conjunction with the systems of FIGS. 1-7, persons skilled in the art will understand that any system configured to perform the method steps, in any order, falls within the scope of the various embodiments.

As shown, step 805 begins at step 1002, scene level policy 520 renders the first virtual environment 512 from multiple views to generate a set of multi-view images. More specifically, scene level policy 520 renders the first virtual environment 512, S₀, from multiple views to generate a set of multi-view images, I₀.

At step 1004, scene level policy 520 processes the set of multi-view images and an input text prompt 502 using a vision language model to generate updates the first virtual environment 512. More specifically, scene level policy 520 inputs the set of multi-view images, I₀, and input text prompt 502, P, into a vision language model π_{θ}, parameterized by θ. The vision language action model outputs an action code a₀~π_{θ}(a|I₀,P) that indicates which large assets or materials from asset library 418 are to be retrieved and added to first virtual environment 512. Scene level policy 520 then updates the first virtual environment 512 by executing the action code a₀. Upon execution of the action policy, scene level policy 520, for example, adjusts the position of a bathtub, adds a table, or increases the lighting of first virtual environment 512 to generate an updated first 3D scene, S₁. In various embodiments, the vision language action model of scene level policy 520 is trained using a self-improvement visual scoring strategy. In each training round, the vision language model,

$${π}_{θ}^{( i )} ,$$

where i denotes the ith training round, generates multiple candidate actions. The actions that yield the highest contrastive language image pre training (CLIP) score between the updated virtual environments and the input text prompt 502 are retained. The actions with the highest CLIP scores are then used to update the parameters of the vision language model, resulting in an improved model

$${π}_{θ}^{( i + 1 )} .$$

The improved model

$${π}_{θ}^{( i + 1 )}$$

can generate new tasks and update virtual environments.

At step 1006, scene level policy repeats steps 1002-1004 a user specified number of times to generate a second virtual environment 522 where large assets, materials, and lighting are added to the first virtual environment 512. More specifically, after a user specified number of iterations, t, scene level policy 520 generates a second virtual environment 522, Sₜ. The second virtual environment 522 is the first virtual environment 512 with large assets, materials, and lighting added.

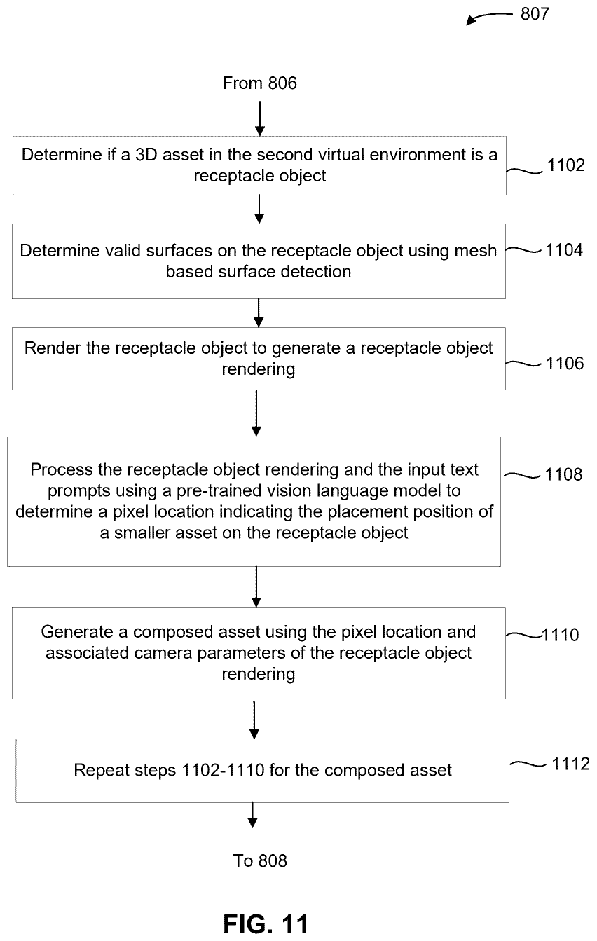

FIG. 11 is a flow diagram of method steps for adding smaller assets to a second virtual environment, according to various embodiments. Although the method steps are described in conjunction with the systems of FIGS. 1-7, persons skilled in the art will understand that any system configured to perform the method steps, in any order, falls within the scope of the various embodiments.

As shown, step 807 begins at step 1102, where receptacle object detector 710 determines if a 3D asset in the second virtual environment 522 is a receptacle object. More specifically, the input data set to receptacle object detector 710 can be any combination of text, audio, image or video, and receptacle object detector 710 generates any combination of text, audio, image or video. Receptacle object detector 710 determines the objects in second virtual environment 522 that are receptacle objects 712. A receptacle object 712 is a larger asset, such as a shelf, table, or counter, where smaller assets, such as books, plates, or utensils, can be placed.

At step 1104, 3D placement policy 720 determines valid surfaces on the receptacle object 712 using mesh based surface detection. More specifically, 3D placement policy 720 uses a mesh-based surface detection approach to find valid surfaces on each receptacle object 712 where smaller assets can be placed.

At step 1106, 3D placement policy 720 renders the receptacle object to generate a receptacle object rendering. More specifically, 3D placement policy 720 renders each receptacle object 712 from a randomly sampled angle on a hemisphere, to generate an image rendering for each receptacle object 712.

At step 1108, 3D placement policy 720 processes the receptacle object rendering and the input text prompt 502 using a pre-trained vision language model to determine the pixel location indicating the placement position of a smaller asset on the receptacle object. More specifically, 3D placement policy 720 inputs the rendered receptacle image and input text prompt 502 into a pre-trained vision language model,

$${π}_{ϕ}^{′} ,$$

where φ are the parameters of the pre-trained vision language model. The pre-trained vision language model outputs an action

$${a}_{k}^{′} = ( {o}_{k}^{′} , {p}_{k}^{′} ) ,$$

where

$${o}_{k}^{′}$$

denotes the pixel location in a rendered receptacle image indicating the placement position of a smaller asset on the receptacle object, and

$${p}_{k}^{′}$$

represents the text description used to retrieve the smaller 3D asset from asset library 418.

At step 1110, 3D placement policy 720 generates a composed asset using the pixel location and associated camera parameters of the receptacle object rendering. More specifically, using the pixel location

$${o}_{k}^{′}$$

and the associated camera parameters, 3D placement policy 720 generates a 3D ray to identify a precise placement point of the smaller asset on the receptacle object. If the location intersects one of the previously identified valid surfaces, then 3D placement policy 720 retrieves the asset from asset library 418 specified by

$${p}_{k}^{′}$$

and generates a composed asset 732.

At step 1112, 3D placement policy 720 repeats steps 1102-1110 for the composed asset 732.

In sum, a virtual environment is generated from an input text prompt. First, a panoramic diffusion model is used to generate a 360 degree scene image with a basic structure for the 3D scene. Next, a segmentation model segments windows and doors from the 360 degree scene image. A vision language model inspects each segmented region to determine the type of region and the material of the region. The rooms, doors, and windows are then procedurally constructed in the corresponding 3D locations to create a first virtual environment. The first virtual environment is rendered from multiple views, and a vision language model fine-tuned using a self-improvement strategy based on visual scoring processes the rendered virtual environment and the input text to generate a policy that adds larger assets, such as beds and tables, materials which describe the surface properties (e.g., wood floor, dark polished tiles), and lighting to the first virtual environment to generate a second virtual environment. Next, a mesh-based surface detection approach identifies whether a 3D asset in the second virtual environment is a receptacle object that can host smaller items. The receptacle object is rendered, and a pre-trained vision language model processes the rendered receptacle object and the input text prompt to generate a policy that iteratively introduces smaller assets, such as books or utensils, to the second virtual environment by placing smaller assets on top of larger assets in a semantically aligned and physically plausible way. When the smaller assets have been added, the second virtual environment is output as a final virtual environment that matches the input text prompt.

At least one technical advantage of the disclosed techniques relative to the prior art is that, with the disclosed techniques large-scale, high-quality virtual environments are generated. The disclosed techniques generate virtual environments where small objects are placed in a semantically coherent manner, thereby ensuring physical plausibility of the virtual environment and generating a virtual environment that is more realistic than prior art approaches to generating virtual environments. In addition, the disclosed techniques iteratively update the virtual environments via self-improvement fine-tuning to generate virtual environments more closely aligned with the input prompt. These technical advantages represent one or more technological improvements over prior art approaches.

Aspects of the subject matter described herein are set out in the following numbered clauses.
1. In some embodiments, a computer-implemented method for generating a virtual environment comprises receiving an input text prompt, generating a first virtual environment based on the input text prompt, generating a second virtual environment by adding a plurality of scene elements to the first virtual environment, and generating a third virtual environment by adding a plurality of additional assets to the second virtual environment, the additional assets being smaller than a first scene element in the plurality of scene elements.
2. The computer-implemented method of clause 1, wherein each scene element in the plurality of scene elements comprises a 3D object, a material, or lighting.
3. The computer-implemented method of clauses 1 or 2, wherein generating the first virtual environment comprises generating a panoramic image from the input text prompt, and deriving a 3D room layout from the panoramic image.
4. The computer-implemented method of any of clauses 1-3, wherein generating the first virtual environment further comprises segmenting a plurality of fixtures from the panoramic image, annotating each segmented fixture of the panoramic image with at least one of a type or a material, and procedurally generating the first virtual environment.
5. The computer-implemented method of any of clauses 1-4, wherein generating the panoramic image comprises using a diffusion model.
6. The computer-implemented method of any of clauses 1-5, wherein each of the plurality of fixtures comprises a door or a window.
7. The computer-implemented method of any of clauses 1-6, wherein procedurally generating the first virtual environment comprises multi-stage conditional sampling.
8. The computer-implemented method of any of clauses 1-7, wherein adding a first scene element of the plurality of scene elements to the first virtual environment comprises rendering the first virtual environment from multiple views to generate a plurality of multi-view images, and processing the plurality of multi-view images and the input text prompt using a vision language model to generate an action code, retrieving the first scene element from an asset library based on the action code and adding the first scene element to the first virtual environment.
9. The computer-implemented method of any of clauses 1-8, wherein the vision language model is trained using a self-improvement visual scoring strategy.
10. The computer-implemented method of any of clauses 1-9, wherein each scene element of the plurality of scene elements is added to the first virtual environment until the first virtual environment matches the input text prompt.
11. The computer-implemented method of any of clauses 1-10, wherein adding a first additional asset of the plurality of additional assets to the second virtual environment comprises determining that a first scene element of the plurality of scene elements is a receptacle object, rendering the receptacle object, generating a composed asset by processing the rendered receptacle object and the input text prompt using a vision language model to determine a placement position of an item smaller than the rendered receptacle object on the receptacle object, and adding the composed asset to the second virtual environment.
12. The computer-implemented method of any of clauses 1-11, wherein the placement position is on a surface of the receptacle object.
13. The computer-implemented method of any of clauses 1-12, wherein determining that the first scene element is a receptacle object comprises using mesh-based surface detection.
14. In some embodiments, one or more non-transitory computer-readable media store instructions that, when executed by at least one processor, cause the at least one processor to perform the steps of receiving an input text prompt, generating a first virtual environment based on the input text prompt, generating a second virtual environment by adding a plurality of scene elements to the first virtual environment, and generating a third virtual environment by adding a plurality of additional assets to the second virtual environment, the additional assets being smaller than a first scene element in the plurality of scene elements.
15. The one or more non-transitory computer-readable media of clause 14, wherein each scene element in the plurality of scene elements comprises a 3D object, a material, or lighting.
16. The one or more non-transitory computer-readable media of clauses 14 or 15, generating the first virtual environment comprises generating a panoramic image from the input text prompt, and deriving a 3D room layout from the panoramic image.
17. The one or more non-transitory computer-readable media of any of clauses 14-16, generating the first virtual environment comprises segmenting a plurality of fixtures from the panoramic image, annotating each segmented fixture of the panoramic image with at least one of a type or a material, and procedurally generating the first virtual environment.
18. The one or more non-transitory computer-readable media of any of clauses 14-17, wherein adding a first scene element of the plurality of scene elements to the first virtual environment comprises rendering the first virtual environment from multiple views to generate a plurality of multi-view images, and processing the plurality of multi-view images and the input text prompt using a vision language model to generate an action code, retrieving the first scene element from an asset library based on the action code and adding the first scene element to the first virtual environment.
19. The one or more non-transitory computer-readable media of any of clauses 14-18, wherein adding a first additional asset of the plurality of additional assets to the second virtual environment comprises determining that a first scene element of the plurality of scene elements is a receptacle object, rendering the receptacle object, generating a composed asset by processing the rendered receptacle object and the input text prompt using a vision language model to determine a placement position of an item smaller than the rendered receptacle object on the receptacle object, and adding the composed asset to the second virtual environment.
20. In some embodiments, a system comprises one or more memories storing instructions, and one or more processors that are coupled to the one or more memories and, when executing the instructions, are configured to perform steps comprising receiving an input text prompt, generating a first virtual environment based on the input text prompt, generating a second virtual environment by adding a plurality of scene elements to the first virtual environment, and generating a third virtual environment by adding a plurality of additional assets to the second virtual environment, the additional assets being smaller than a first scene element in the plurality of scene elements.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating a virtual environment, the method comprising:
receiving an input text prompt;
generating a first virtual environment based on the input text prompt;
generating a second virtual environment by adding a plurality of scene elements to the first virtual environment; and
generating a third virtual environment by adding a plurality of additional assets to the second virtual environment, the additional assets being smaller than a first scene element in the plurality of scene elements.

2. The computer-implemented method of claim 1, wherein each scene element in the plurality of scene elements comprises a 3D object, a material, or lighting.

3. The computer-implemented method of claim 1, wherein generating the first virtual environment comprises:
generating a panoramic image from the input text prompt; and
deriving a 3D room layout from the panoramic image.

4. The computer-implemented method of claim 3, wherein generating the first virtual environment further comprises:
segmenting a plurality of fixtures from the panoramic image;
annotating each segmented fixture of the panoramic image with at least one of a type or a material; and
procedurally generating the first virtual environment.

5. The computer-implemented method of claim 3, wherein generating the panoramic image comprises using a diffusion model.

6. The computer-implemented method of claim 4, wherein each of the plurality of fixtures comprises a door or a window.

7. The computer-implemented method of claim 4, wherein procedurally generating the first virtual environment comprises multi-stage conditional sampling.

8. The computer-implemented method of claim 1, wherein adding a first scene element of the plurality of scene elements to the first virtual environment comprises:
rendering the first virtual environment from multiple views to generate a plurality of multi-view images; and
processing the plurality of multi-view images and the input text prompt using a vision language model to generate an action code
retrieving the first scene element from an asset library based on the action code and
adding the first scene element to the first virtual environment.

9. The computer-implemented method of claim 8, wherein the vision language model is trained using a self-improvement visual scoring strategy.

10. The computer-implemented method of claim 1, wherein each scene element of the plurality of scene elements is added to the first virtual environment until the first virtual environment matches the input text prompt.

11. The computer-implemented method of claim 1, wherein adding a first additional asset of the plurality of additional assets to the second virtual environment comprises:
determining that a first scene element of the plurality of scene elements is a receptacle object;
rendering the receptacle object;
generating a composed asset by processing the rendered receptacle object and the input text prompt using a vision language model to determine a placement position of an item smaller than the rendered receptacle object on the receptacle object; and
adding the composed asset to the second virtual environment.

12. The computer-implemented method of claim 11, wherein the placement position is on a surface of the receptacle object.

13. The computer-implemented method of claim 11, wherein determining that the first scene element is a receptacle object comprises using mesh-based surface detection.

14. One or more non-transitory computer-readable media storing instructions that, when executed by at least one processor, cause the at least one processor to perform the steps of:
receiving an input text prompt;
generating a first virtual environment based on the input text prompt;
generating a second virtual environment by adding a plurality of scene elements to the first virtual environment; and
generating a third virtual environment by adding a plurality of additional assets to the second virtual environment, the additional assets being smaller than a first scene element in the plurality of scene elements.

15. The one or more non-transitory computer-readable media of claim 14, wherein each scene element in the plurality of scene elements comprises a 3D object, a material, or lighting.

16. The one or more non-transitory computer-readable media of claim 14, wherein generating the first virtual environment comprises:
generating a panoramic image from the input text prompt; and
deriving a 3D room layout from the panoramic image.

17. The one or more non-transitory computer-readable media of claim 16, wherein generating the first virtual environment comprises:
segmenting a plurality of fixtures from the panoramic image;
annotating each segmented fixture of the panoramic image with at least one of a type or a material; and
procedurally generating the first virtual environment.

18. The one or more non-transitory computer-readable media of claim 14, wherein adding a first scene element of the plurality of scene elements to the first virtual environment comprises:
rendering the first virtual environment from multiple views to generate a plurality of multi-view images; and
processing the plurality of multi-view images and the input text prompt using a vision language model to generate an action code
retrieving the first scene element from an asset library based on the action code and
adding the first scene element to the first virtual environment.

19. The one or more non-transitory computer-readable media of claim 14, wherein adding a first additional asset of the plurality of additional assets to the second virtual environment comprises:
determining that a first scene element of the plurality of scene elements is a receptacle object;
rendering the receptacle object;
generating a composed asset by processing the rendered receptacle object and the input text prompt using a vision language model to determine a placement position of an item smaller than the rendered receptacle object on the receptacle object; and
adding the composed asset to the second virtual environment.

20. A system, comprising:
one or more memories storing instructions; and
one or more processors that are coupled to the one or more memories and, when executing the instructions, are configured to perform steps comprising:
receiving an input text prompt;
generating a first virtual environment based on the input text prompt;
generating a second virtual environment by adding a plurality of scene elements to the first virtual environment; and
generating a third virtual environment by adding a plurality of additional assets to the second virtual environment, the additional assets being smaller than a first scene element in the plurality of scene elements.
